(19) United States
(12) Patent Application Publication
(10) Pub. No.: US 2026/0025746 A1
(43) Pub. Date: Jan. 22, 2026

(54) WIRELESS NETWORK SLICE CONTROL BASED ON A RADIO FREQUENCY METRIC

(71) Applicant: T-MOBILE INNOVATIONS LLC, Overland Park, KS (US)

(72) Inventors: Timur Kochiev, Irvine, CA (US); Relin Thomas, Seattle, WA (US)

(21) Appl. No.: 18/779,979

(22) Filed: Jul. 22, 2024

(51) Int. Cl. H04W 48/18; H04W 48/14

(52) U.S. Cl. CPC H04W 48/18; H04W 48/14

(57) ABSTRACT

A wireless communication device exchanges user data with a wireless network slice. The wireless network slice has Radio Frequency (RF) information that controls slice usage. The wireless communication device determines an RF metric for a wireless communication link. The wireless communication device or the wireless communication network process the RF metric and the RF information to select another network slice. In response to the slice selection, the wireless communication device and the wireless communication network stop the exchange of the user data with the wireless network slice and start to exchange user data with another wireless network slice.

### TECHNICAL BACKGROUND

Wireless communication networks provide data services to wireless communication devices like phones, computers, and other user devices. The data services may include internet-access, data messaging, video conferencing, or some other data communication product. The wireless communication networks comprise wireless access nodes like Wireless Fidelity (WIFI) hotspots, Fifth Generation New Radio (5GNR) cell towers, and satellites in earth orbit. The wireless communication devices and the wireless access nodes communicate over wireless links that have various metrics like received signal strength and signal-to-noise ratio. The wireless communication networks further comprise network elements that process network signaling and handle user data like Access and Mobility Management Functions, Session Management Functions (SMFs), User Plane Functions (UPFs), and Unified Data Management (UDMs).

Wireless network slices comprise network elements like UPFs and SMFs that are customized for specific features or services. For example, a wireless network slice that serves an augmented reality display may be customized to provide low-latency communications. A wireless network slice that serves media-streaming may be customized to provide high-throughput media downloading. The wireless communication devices typically request specific slices to serve the user applications that they are currently executing.

### TECHNICAL OVERVIEW

In some examples, a wireless communication network comprises a wireless access node and a network control system. The wireless access node exchanges user data with a wireless communication device that uses a wireless network slice. The network control system transfers Radio Frequency (RF) information that controls usage of the wireless network slice to the wireless access node. The wireless access node receives an RF metric for a wireless communication link from the wireless communication device. The wireless access node processes the RF metric and the RF information, and in response, selects another network slice. In response to the selection, the wireless access node stops the exchange of the user data with the wireless communication device which stops using the wireless network slice. The wireless access node starts to exchange other user data with the wireless communication device that starts to use the other network slice.

In some examples, a method comprises the following. Exchange user data with a wireless communication device that is using a wireless network slice. The wireless network slice has RF information that controls slice usage. Receive an RF metric for a wireless communication link from the wireless communication device. Process the RF metric and the RF information, and in response, select another network slice. Stop the exchange of the user data with the wireless communication device which stops using the wireless network slice. Start to exchange other user data with the wireless communication device that starts to use the other network slice.

In some examples, a method comprises the following. Receive a request from a wireless communication device to use a wireless network slice. In response to the request, transfer RF information to the wireless communication device that controls slice usage. Exchange user data with the wireless communication device that is using the wireless network slice. The wireless communication device determines an RF metric for a wireless communication link and selects the other network slice based on the RF metric and the RF information. Receive another request from the wireless communication device to use the other network slice. In response to the other request, exchange other user data with the wireless communication device which starts to use the other network slice.

In some examples, a wireless communication device comprises a device control system and a radio. The device control system requests a wireless network slice and receives RF information that controls usage of the wireless network slice. The radio exchanges user data to use the wireless network slice. The device control system determines an RF metric for a wireless communication link. The device control system selects another network slice based on the RF metric and the RF information, and in response, requests the other wireless network slice. The radio exchanges other user data to use the other network slice.

In some examples, a method comprises the following. Exchange user data to use a wireless network slice. The wireless network slice has RF information that controls usage of the wireless network slice. Determine an RF metric for a wireless communication link and transfer the RF metric to a wireless communication network that selects another network slice based on the RF metric and the RF information. Receive a network instruction from the wireless communication network to use the other network slice in response to the selection. Exchange other user data to use the other network slice.

In some examples, a method comprises the following. Request a wireless network slice and receive RF information that controls usage of the wireless network slice. Exchange user data to use the wireless network slice. Determine an RF metric for a wireless communication link. Select another network slice based on the RF metric and the RF information, and in response, request the other wireless network slice. Exchange other user data to use the other network slice.

### DESCRIPTION OF THE DRAWINGS

FIG. 1 illustrates an exemplary data communication system to control slice usage based on a Radio Frequency (RF) metric.

FIG. 2 illustrates an exemplary operation of the data communication system to control slice usage based on the RF metric.

FIG. 3 illustrates an exemplary operation of the data communication system to control slice usage based on the RF metric.

FIG. 4 illustrates an exemplary operation of the data communication system to control slice usage based on the RF metric.

FIG. 5 illustrates an exemplary operation of the data communication system to control slice usage based on the RF metric.

FIG. 6 illustrates exemplary processing circuitry to authorize a wireless UE for a content service.

FIG. 7 illustrates an exemplary wireless communication network to control slice usage based on an RF metric.

FIG. 8 illustrates an exemplary UE in the wireless communication network that controls slice usage based on the RF metric.

FIG. 9 illustrates an exemplary Fifth Generation New Radio (5GNR) access node in the wireless communication network that controls slice usage based on the RF metric.

FIG. 10 illustrates an exemplary Wireless Fidelity (WIFI) access node in the wireless communication network that controls slice usage based on the RF metric.

FIG. 11 illustrates an exemplary satellite access node and ground station in the wireless communication network that controls slice usage based on the RF metric.

FIG. 12 illustrates an exemplary Network Function Virtualization Infrastructure (NFVI) in the wireless communication network that controls slice usage based on the RF metric.

FIG. 13 illustrates an exemplary operation of the wireless communication network that controls slice usage based on the RF metric.

FIG. 14 illustrates an exemplary operation of the wireless communication network that controls slice usage based on the RF metric.

### DETAILED DESCRIPTION

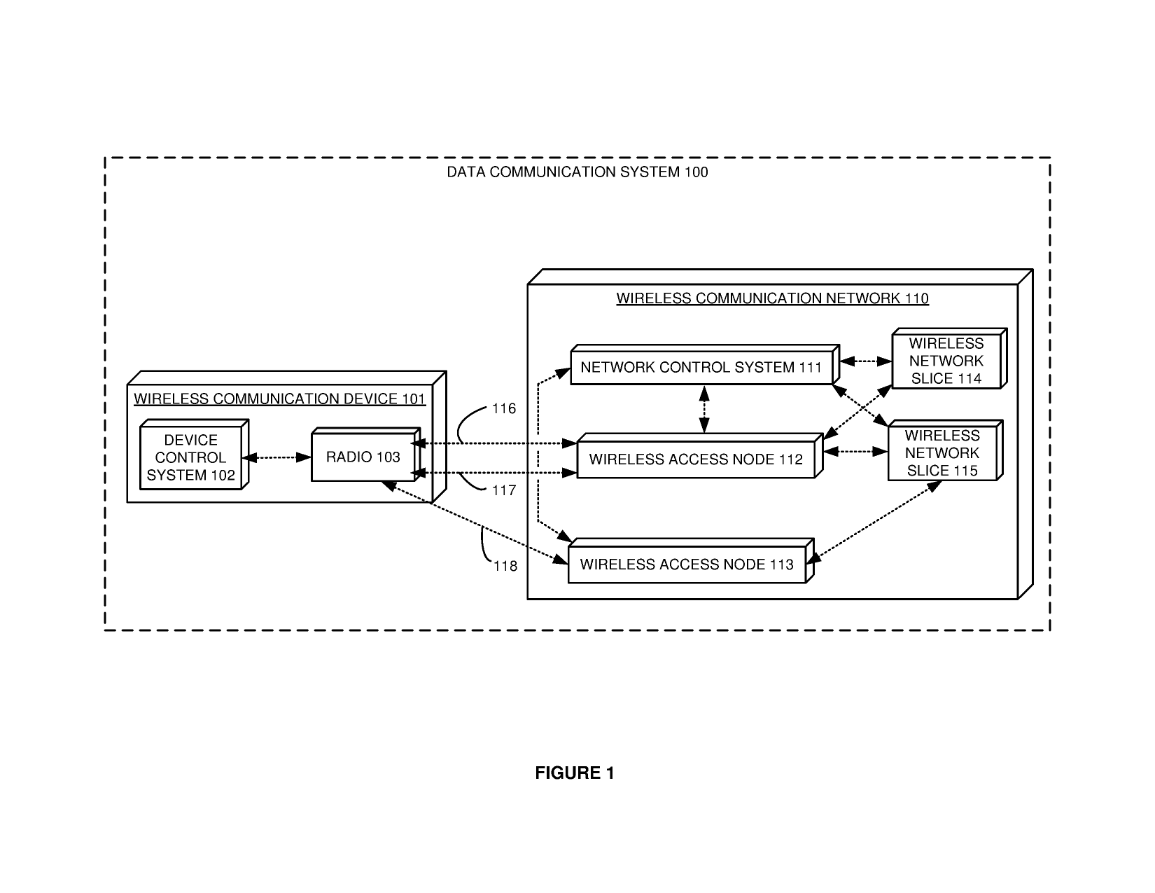

FIG. 1 illustrates exemplary data communication system 100 to control slice usage based on a Radio Frequency (RF) metric. Data communication system 100 comprises wireless communication device 101 and wireless communication network 110. Wireless communication device 101 comprises device control system 102 and radio 103. Wireless communication network 110 comprises network control system 111, wireless access nodes 112-113, and wireless network slices 114-115. Wireless communication device 101 and wireless access node 112 exchange user data over wireless communication links 116-117. Wireless communication device 101 and wireless access node 113 exchange user data over wireless communication link 118. Although shown separately on FIG. 1, wireless network slice 114 may include wireless access node 112 and/or wireless communication links 116-117. Wireless network slice 115 may include wireless access node 113 and/or wireless communication link 118.

Wireless communication links 116-118 are characterized by RF metrics like Reference Signal Receive Power (RSRP), Signal-to-Noise Ratio (SNR), Signal-to-Interference and Noise Ratio (SINR), power headroom, error rate, data throughput, data latency, or some other measurable technical characteristic of wireless communications. Wireless network slices 114-115 have RF information that controls their slice usage. The RF information may indicate the next slice that should be used when the RF metric does not support the current slice. For example, the RF information for wireless network slice 114 may have an RSRP threshold and/or a SINR threshold that must be met by wireless communication device 101 to use slice 114. When the RSRP threshold and/or the SINR threshold is not met by wireless communication device 101, then device 101 uses wireless network slice 115. Multiple RF metrics may be used in combination with various components of RF information, and the term “RF metric” does not require that only a single RF metric be used for slice control.

In some examples, network control system 111 transfers RF information that controls the use of slice 114 to wireless access node 112. Device control system 102 and wireless network slice 114 exchange user data over radio 103, wireless communication link 116, and wireless access node 112. Device control system 102 determines at least one RF metric for wireless communication link 116. Device control system 102 transfers the RF metric(s) to wireless access node 112 over radio 103 and wireless communication link 116. Wireless access node 112 selects wireless network slice 115 based on the RF metric(s) and the RF information. For example, an RF metric may indicate that the RSRP for wireless communication link 116 is below a power threshold that is required by the RF information for device 101 to use wireless network slice 114. The RF information may also indicate that slice 115 should be used when the RF metric does not support slice 114. Wireless access node 112 transfers an instruction to device control system 102 over wireless communication link 116 and radio 103. The instruction is to stop using slice 114 and to start using slice 115. Device control system 102 and wireless network slice 114 stop the exchange of the user data over radio 103, wireless communication link 116, and wireless access node 112. Device control system 102 and wireless network slice 115 start to exchange user data over radio 103, wireless communication link 116, and wireless access node 112. Alternatively, wireless access node 112 may select wireless communication link 117 based on the RF metric(s) and the RF information, and then then radio 103 and wireless access node 112 would use link 117 for wireless communication device 101 to access to slice 115 instead of using link 116. In another alternative, wireless access node 112 may select wireless access node 113 and/or wireless communication link 118 based on the RF metric(s) and the RF information, and then then radio 103 and wireless access node 113 would use wireless access node 113 and link 118 for wireless communication device 101 to access to slice 115 instead of wireless access node 112 and link 116.

In some examples, device control system 102 transfers a request for wireless network slice 114 to network control system 111 over radio 103, wireless communication link 116, and wireless access node 112. In response to the request, network control system 111 transfers RF information that controls the use of wireless network slice 114 to device control system 102 over wireless access node 112, wireless communication link 116, and radio 103. In some examples, wireless access node 112 transfers a request for the RF metric to device control system 102 which responsively returns the RF metric to wireless access node 112. Device control system 102 exchanges user data with wireless network slice 114 over radio 103, wireless communication link 116, and wireless access node 112. Device control system 102 determines at least one RF metric for wireless communication link 116. Device control system 102 selects wireless network slice 115 based on the RF metric(s) and the RF information. For example, an RF metric may indicate that the SINR for wireless communication link 116 is below a ratio threshold that is specified in the RF information for wireless communication device to use wireless network slice 114. The RF information may indicate that slice 115 should be used when the RF metric does not support slice 114. In response to the slice selection, device control system 102 transfers a request for wireless network slice 115 to network control system 111 over radio 103, wireless communication link 116, and wireless access node 112. In response to the request, device control system 102 exchanges user data with wireless network slice 115 over radio 103, wireless communication link 116, and wireless access node 112. Alternatively, device control system 102 may select wireless communication link 117 based on the RF metric(s) and the RF information, and then then radio 103 and wireless access node 112 would use link 117 instead of link 116 for wireless communication device 101 to access to slice 115. In another alternative, device control system 102 may select wireless access node 113 and/or wireless communication link 118 based on the RF metric(s) and the RF information, and then then radio 103 and wireless access node 113 would use wireless access node 113 and link 118 instead of node 112 and link 116 for wireless communication device 101 to access to wireless network slice 115.

In some examples, wireless communication device 101 comprises a vehicle like an aerial drone or robotic automobile. Wireless network slices 114-115 may comprise vehicle-control slices that track vehicle movement and provide navigation support. The navigation support may comprise directions to a location, instructions on where to be when capturing video, or some other similar information. For example, the navigation instruction may guide an aerial camera to a building site and then direct the aerial camera to take video at particular locations of the building exterior where repair work is being performed. In another example, the navigation instruction may guide a robotic automobile to a delivery site and then direct the robotic automobile to move a package from the automobile to a delivery platform. The user data transferred from wireless communication device 101 to wireless network slices 114-115 may comprise video data and/or location data, and the user data transferred from wireless network slices 114-115 to wireless communication device 101 may comprise navigation and/or velocity instructions. The velocity instructions indicate vehicle speed. Wireless communication device 101 implements the navigation and/or velocity instructions.

In some examples, network control system 111 modifies the RF information that controls the usage of wireless network slice. The modification of the RF information changes the physical boundary of wireless network slice 114. For example, network control system 111 may lower an RSRP threshold for slice 114 which increases the geographic area served by slice 114. Network control system 111 may generate a coverage map for wireless network slice 114 based on a physical location of wireless communication device 101 when wireless network slice 115 is selected. By aggregating the data of multiple such slice switches, the three dimensional boundary of slice 114 could be mapped to geographic coordinates. Network control system 111 may use RF metrics and RF information to control slice usage in a similar manner to device control system 102 or wireless access node 111.

In some examples, wireless access node 112 and radio 103 use Multiple Input Multiple Output (MIMO) beamforming to exchange the user data over wireless communication link 116. For MIMO beamforming, wireless access node 112 uses multiple antennas to focus a wireless signal beam on wireless communication device 101. The multiple antennas are driven by a beamforming matrix that indicates transmit power and phase for each antenna. Device control system 102 may select the beamforming matrix based on the received signal and transfer a corresponding beamforming matrix indicator to wireless access node 112 over radio 103 and wireless communication link 116.

Wireless communication device 101 comprises a phone, computer, vehicle, sensor, or some other user apparatus with wireless communication components. Network control system 111 comprises an Access and Mobility Management Function (AMF), Unified Data Management (UDM), Session Management Function (SMF), or some other network elements. Wireless access nodes 112-113 comprise Fifth Generation New Radio (5GNR) NodeBs, satellite, wireless fidelity hotspots, or some other data communication equipment with wireless communication components. Wireless network slices 114-115 comprise User Plane Functions (UPFs), SMFs, routers, gateways, wireless access nodes, wireless communication links, or some other network elements. Radio 103 and wireless access nodes 112-113 wirelessly communicate over wireless links 116-118 using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and satellite data communications. Device control system 102, radio 103, network control system 111, wireless access nodes 112-113, and slices 114-115 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data communication system 100 as described herein.

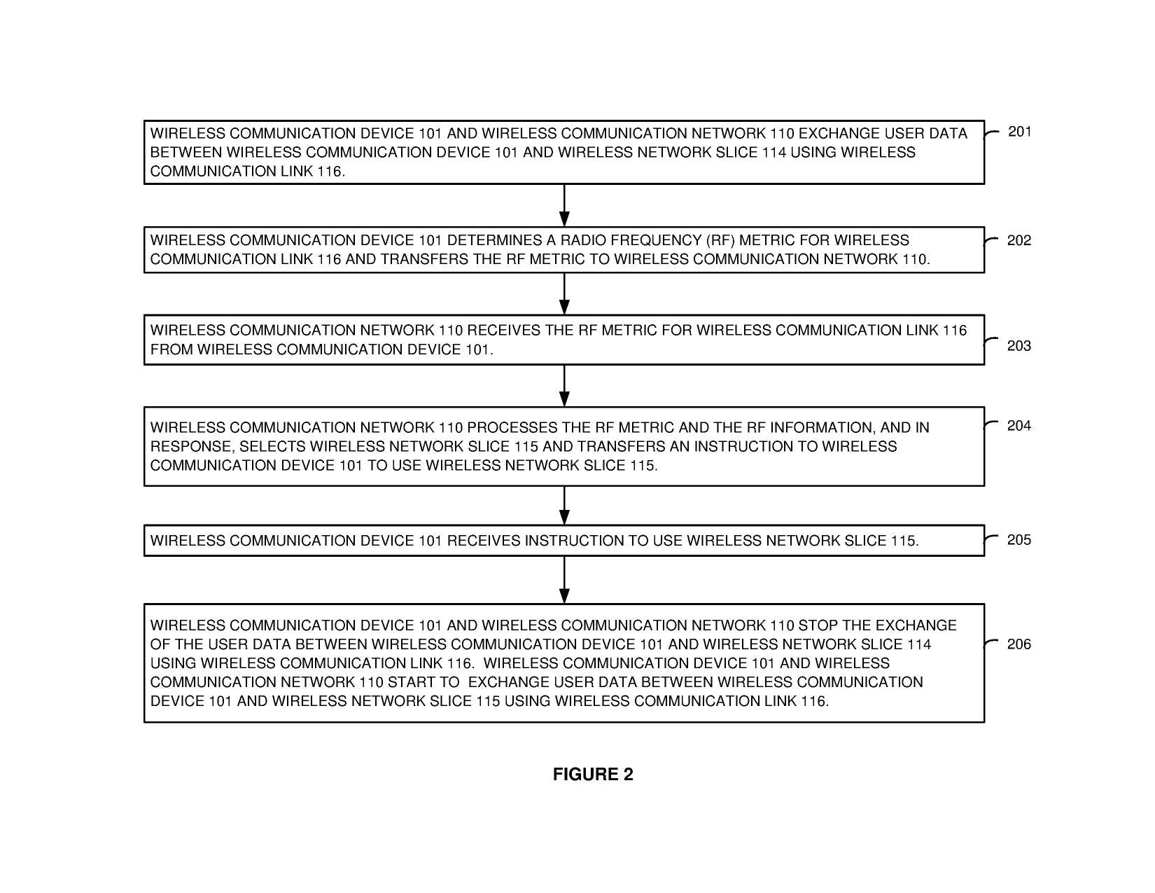

FIG. 2 illustrates an exemplary operation of data communication system 100 to control slice usage based on the RF metric. In this example, wireless communication network 110 controls slice usage based on the RF metric and the RF information. The operation may vary in other examples. Wireless communication device 101 and wireless communication network 110 exchange user data between wireless communication device 101 and wireless network slice 114 using wireless communication link 116 (201). Wireless communication device 101 determines an RF metric for wireless communication link 116 and transfers the RF metric to wireless communication network 110 (202). Wireless communication network 110 receives the RF metric for wireless communication link 116 from wireless communication device 101 (203). Wireless communication network 110 processes the RF metric and the RF information, and in response, selects wireless network slice 115 and transfers an instruction to wireless communication device 101 to use wireless network slice 115 (204). Wireless communication device 101 receives the instruction to use wireless network slice 115 (205). Wireless communication device 101 and wireless communication network 110 stop the exchange of the user data between wireless communication device 101 and wireless network slice 114 using wireless communication link 116 (206). Wireless communication device 101 and wireless communication network 110 start to exchange user data between wireless communication device 101 and wireless network slice 115 using wireless communication link 116 (206). In alternative examples, wireless communication link 116 is a part of wireless network slice 114, and wireless access node 112 may use wireless communication links 117-118 and/or wireless access node 113 to exchange the user data between wireless communication device 101 and wireless network slice 115.

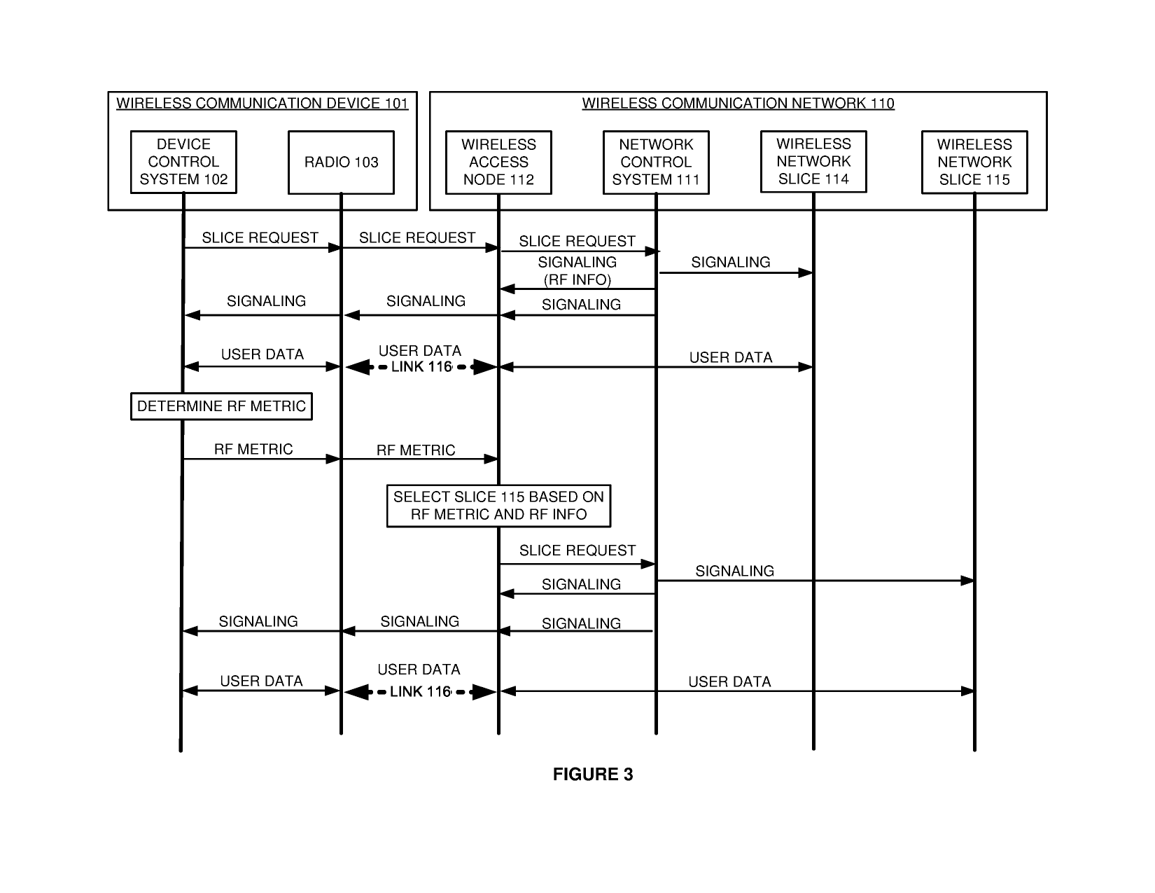

FIG. 3 illustrates an exemplary operation of data communication system 100 to control slice usage based on the RF metric. In this example, wireless communication network 110 controls slice usage based on the RF metric and the RF information. The operation may vary in other examples. Device control system 102 transfers a slice request to use wireless network slice 114 to network control system 111 over radio 103 and wireless access node 112. Network control system 111 transfers signaling to implement the use of wireless network slice 114 to wireless access node 112 and wireless network slice 114. The signaling from network control system 111 to wireless access node 112 includes RF information to control slice usage. Network control system 111 transfers signaling to implement the use of slice 114 to device control system 102 over wireless access node 112 and radio 103. Device control system 102 and wireless network slice 114 exchange user data over radio 103, wireless communication link 116, and wireless access node 112. Device control system 102 determines an RF metric for wireless communication link 116. Device control system 102 transfers the RF metric to wireless access node 112 over radio 103. Wireless access node 112 selects wireless network slice 115 based on the RF metric and the RF information. For example, the RF information may indicate that slice 115 should be used when the SINR when using slice 114 falls below a ratio threshold. Wireless access node 112 transfers a request for slice 115 for wireless communication device 101 to network control system 111. Network control system 111 transfers signaling to implement the use of slice 115 to wireless access node 112 and wireless network slice 115. Network control system 111 transfers signaling to implement the use of slice 115 to device control system 102 over wireless access node 112 and radio 103. In response to the signaling, device control system 102 and wireless network slice 114 stop the exchange user data over radio 103, wireless communication link 116, and wireless access node 112. In response to the signaling, device control system 102 and wireless network slice 115 start to exchange user data over radio 103, wireless communication link 116, and wireless access node 112. In alternative examples, wireless communication link 116 and wireless access node 112 are part of wireless network slice 114, and wireless access node 112 may use wireless communication links 117-118 and/or wireless access node 113 to exchange the user data between wireless communication device 101 and wireless network slice 115.

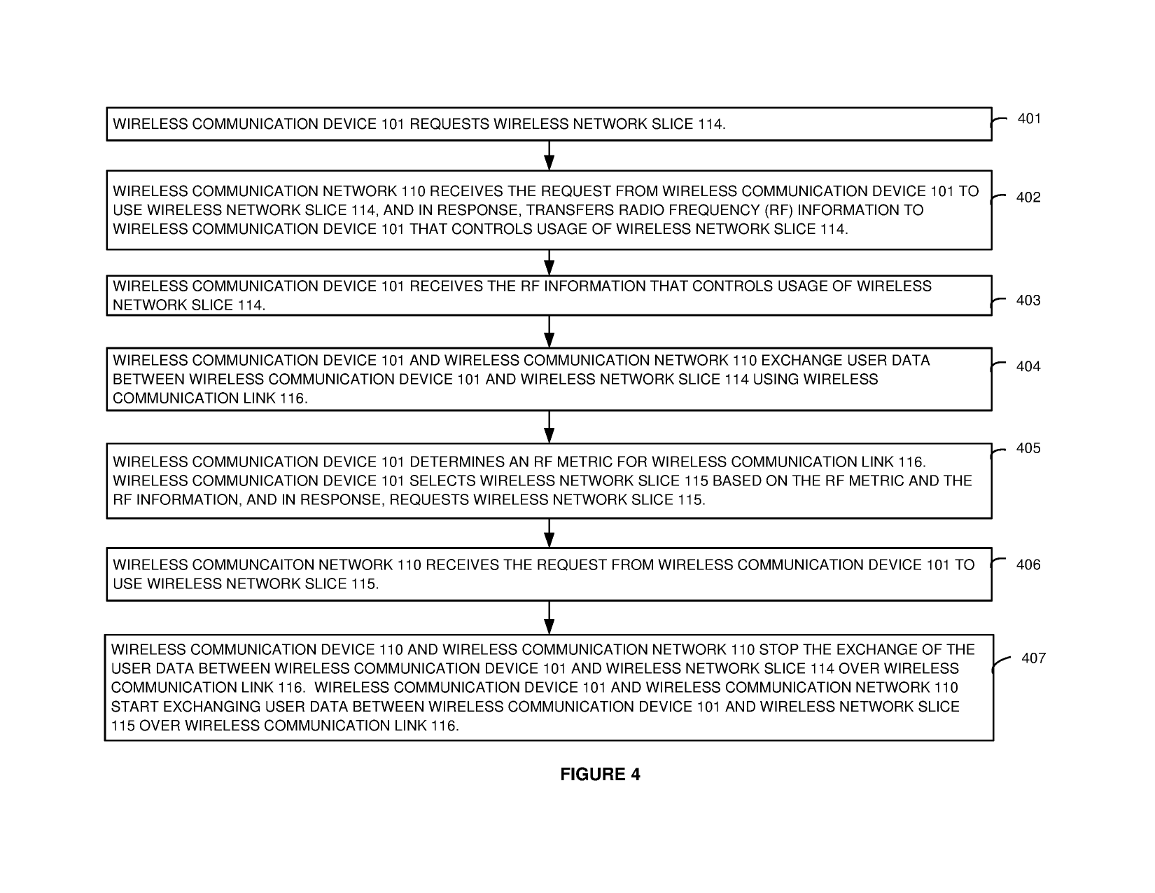

FIG. 4 illustrates an exemplary operation of data communication system 100 to control slice usage based on the RF metric. In this example, wireless communication device 101 controls slice usage based on the RF metric and the RF information. The operation may vary in other examples. Wireless communication device 101 requests wireless network slice 114 (401). Wireless communication network 110 receives the request from wireless communication device 101 to use wireless network slice 114, and in response, transfers RF information to wireless communication device 101 that controls the use of wireless network slice 114 (402). Wireless communication device 101 receives the RF information that controls usage of wireless network slice 114 (403). Wireless communication device 101 and wireless communication network 110 exchange user data between wireless communication device 101 and wireless network slice 114 using wireless communication link 116 (404). Wireless communication device 101 determines an RF metric for wireless communication link 116 (405). Wireless communication device 101 selects wireless network slice 115 based on the RF metric and the RF information, and in response, requests wireless network slice 115 (405). Wireless communication network 110 receives the request from wireless communication device 101 to use wireless network slice 115 (406). Wireless communication device 101 and wireless communication network 110 stop exchanging user data between wireless communication device 101 and wireless network slice 114 over wireless communication link 116 (407). Wireless communication device 101 and wireless communication network 110 start exchanging user data between wireless communication device 101 and wireless network slice 115 over wireless communication link 116 (407). In alternative examples, wireless communication link 116 is a part of wireless network slice 114, and wireless access node 112 may use wireless communication links 117-118 and/or wireless access node 113 to exchange the user data between wireless communication device 101 and wireless network slice 115.

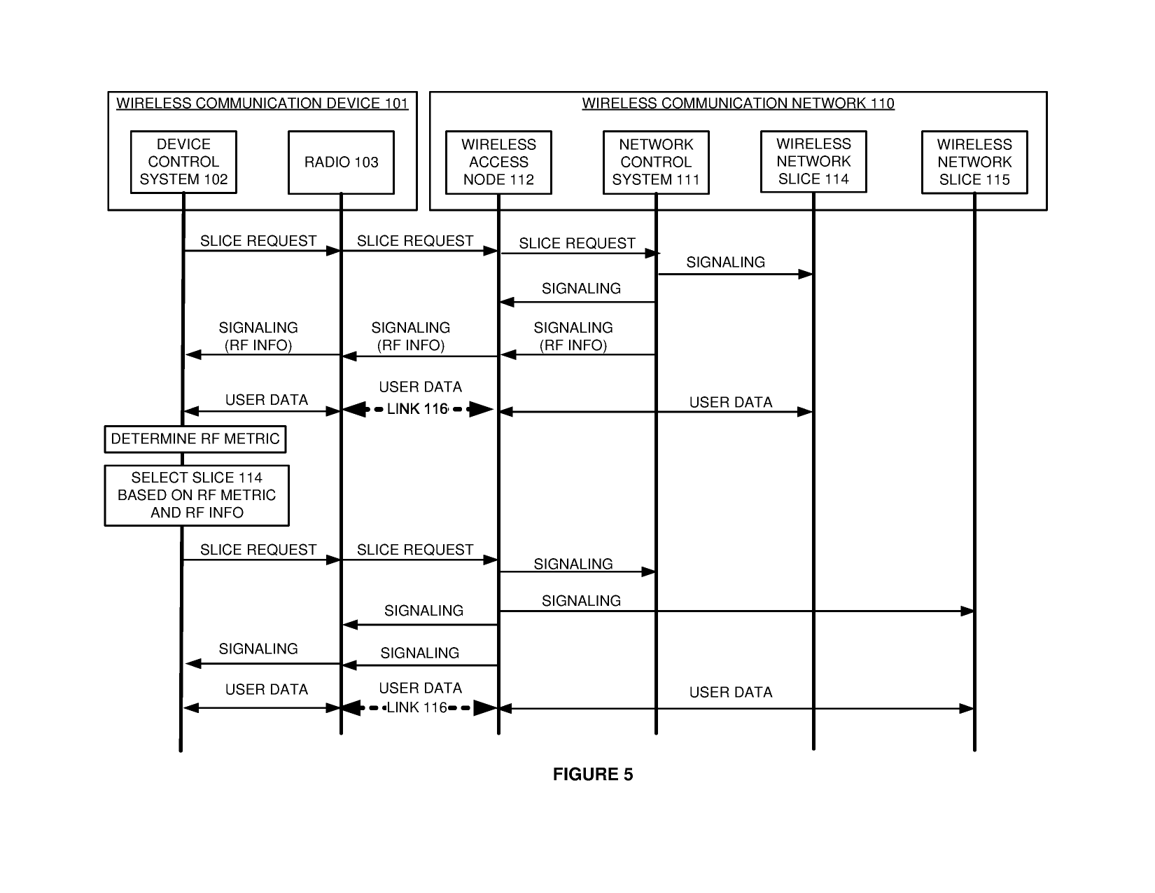

FIG. 5 illustrates an exemplary operation of data communication system 100 to control slice usage based on the RF metric. In this example, wireless communication device 101 controls slice usage based on the RF metric and the RF information. The operation may vary in other examples. Device control system 102 transfers a slice request to use wireless network slice 114 to network control system 111 over radio 103 and wireless access node 112. Network control system 111 transfers signaling to implement the use of slice 114 to wireless network slice 114 and wireless access node 112. Network control system 111 transfers signaling to implement the use of slice 114 to device control system 102 over wireless access node 112 and radio 103. The signaling from network control system 111 to device control system 102 includes RF information to control slice usage. Device control system 102 and wireless network slice 114 exchange user data over radio 103, wireless communication link 116, and wireless access node 112. Device control system 102 determines an RF metric for wireless communication link 116. Device control system 102 selects wireless network slice 115 based on the RF metric and the RF information. For example, the RF information may indicate that slice 115 should be used when the RSRP when using slice 114 falls below a power threshold. In response to the slice selection, device control system 102 transfers a slice request to use wireless network slice 115 to network control system 111 over radio 103 and wireless access node 112. Network control system 111 transfers signaling to implement the use of slice 115 to wireless network slice 115 and wireless access node 112. Network control system 111 transfers signaling to implement the use of slice 115 to device control system 102 over wireless access node 112 and radio 103. In response to the signaling, device control system 102 and wireless network slice 114 stop the exchange of user data over radio 103 and wireless access node 112. In response to the signaling, device control system 102 and wireless network slice 115 start to exchange user data over radio 103, wireless communication link 116, and wireless access node 112. In alternative examples, wireless communication link 116 and wireless access node 112 are part of wireless network slice 114, and wireless access node 112 may use wireless communication links 117-118 and/or wireless access node 113 to exchange the user data between wireless communication device 101 and wireless network slice 115.

Advantageously, data communication system 100 efficiently controls slice usage based on RF metrics for wireless communication link 116 that is used by wireless communication device 101. Moreover, data communication system 100 effectively coordinates the capabilities of wireless network slices 114-115 with the qualities of wireless communication link 116.

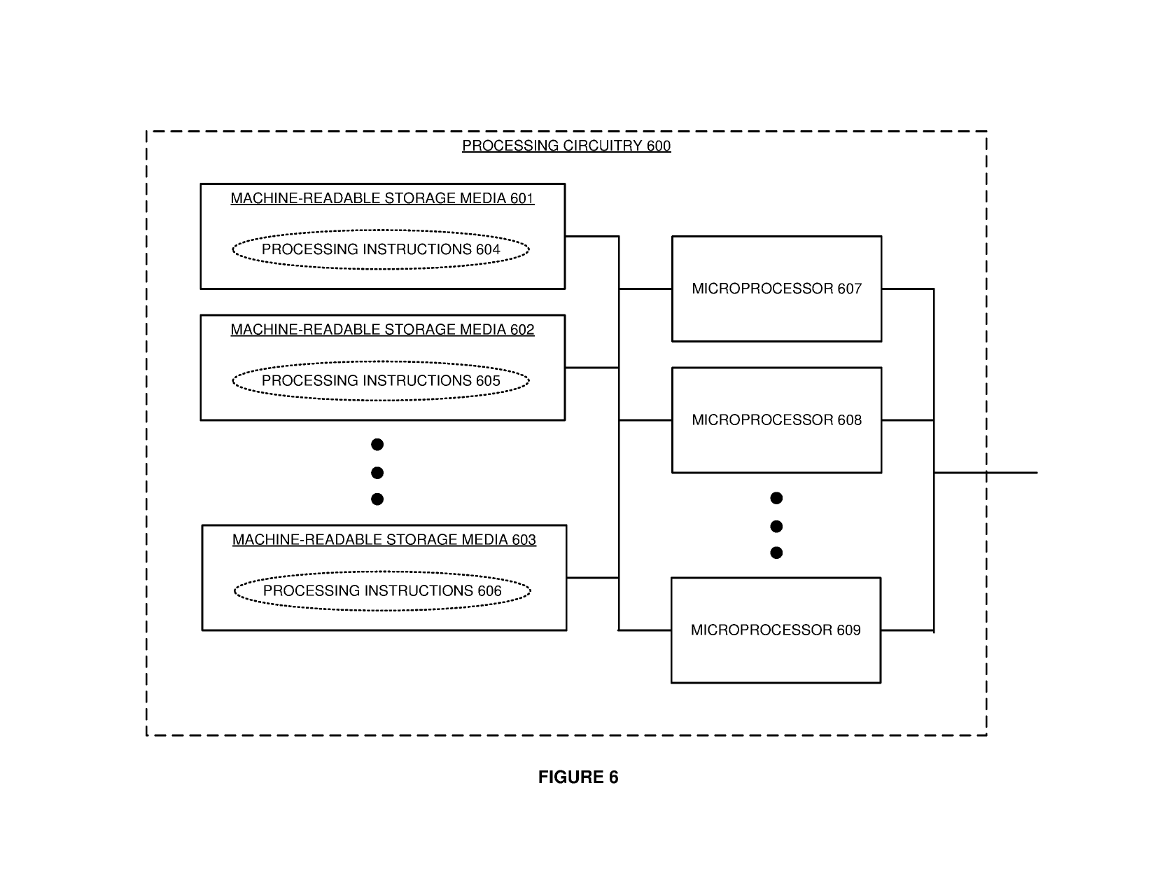

FIG. 6 illustrates exemplary processing circuitry 600 to control slice usage based on an RF metric. Processing circuitry 600 comprises an example of wireless communication device 101 and wireless communication network 110, although device 101 and network 110 may differ. Processing circuitry 600 comprises machine-readable storage media 601-603 and microprocessors 607-609 that are communicatively coupled. Machine-readable storage media 601-603 store processing instructions 604-606 in a non-transitory manner. Microprocessors 607-609 comprise DSPs, CPUs, GPUs, ASICs, and/or some other data processing hardware. Machine-readable storage media 601-603 comprises RAM, flash circuitry, disk drives, and/or some other type of data storage apparatus. Microprocessors 607-609 retrieve processing instructions 604-606 from non-transitory machine-readable storage media 601-603. Microprocessors 607-609 execute processing instructions 604-606 to control slice usage based on RF metrics and RF information as described above for data communication system 100 and as described below for wireless communication network 700. The amount of storage media, microprocessors, processing instructions that are shown in FIG. 6 may vary in other examples.

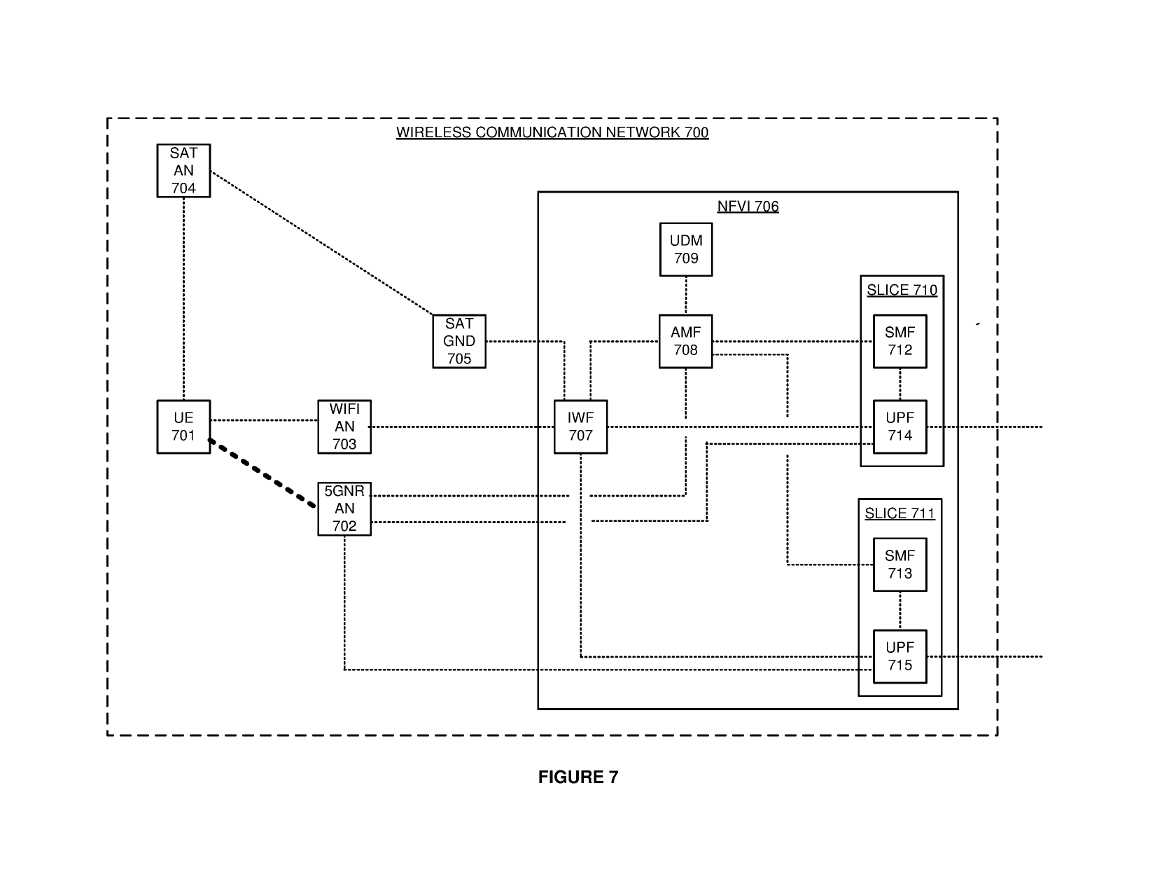

FIG. 7 illustrates exemplary wireless communication network 700 to control slice usage based on an RF metric. Wireless communication network 700 comprises an example of data communication system 100 and processing circuitry 600, although system 100 and circuitry 600 may differ. Wireless communication network 700 comprises User Equipment (UE) 701, Fifth Generation New Radio (5GNR) Access Node (AN) 702, Wireless Fidelity (WIFI) AN 703, Satellite Access Node (SAT AN) 704, satellite ground station (SAT GND) 705, and Network Function Virtualization Infrastructure (NFVI) 706. NFVI 706 comprises Interworking Function (IWF) 707, Access and Mobility Management Function (AMF) 708, Unified Data Management (UDM) 709, and wireless network slices 710-711. Wireless network slice 710 comprises Session Management Function (SMF) 712 and User Plane Function (UPF) 714. Wireless network slice 711 comprises SMF 713 and UPF 715.

In a first example, 5GNR AN 702 controls slice usage based on one or more RF metrics. UE 701 transfers a request to use wireless network slice 710 to AMF 708 over 5GNR AN 702. AMF 708 retrieves UE information for UE 701 from UDM 709. The UE information includes an authorization for UE 701 to use slice 710. The UE information also includes RF information that controls the use of slice 710 by initiating a switch from slice 710 to slice 711 based on the RF metrics. AMF 708 and SMF 712 interact to develop context for UE 701 like network addresses, quality-of-service levels, and the RF information for slice 710. SMF 712 transfers context to UPF 714. AMF 708 transfers context that includes the RF information to 5GNR AN 702. AMF 708 transfers context to UE 701 over 5GNR AN 702. In response to the context, UE 701 exchanges user data with a data system like a navigation server (not shown) over 5GNR AN 702 and UPF 714.

UE 701 determines an RF metric for the exchange of user data over a wireless communication link between UE 701 and 5GNR AN 702. UE 701 transfers the RF metric to 5GNR AN 702. 5GNR AN 702 may request the RF metric from UE 701 which responsively returns the RF metric to 5GNR AN 701. 5GNR AN 702 selects wireless network slice 711 based on the RF metric and the RF information. For example, the RF information may specify a minimum RSRP and a maximum error rate to use slice 710 and that slice 711 should be used when these requirements are not met. The RF metrics may indicate an RSRP below the RSRP minimum and an error rate above the error rate maximum – so slice 711 is then used.

5GNR AN 702 transfers a request for UE 701 to use wireless network slice 711 to AMF 708. AMF 708 retrieves UE information for UE 701 from UDM 709. The UE information includes an authorization for UE 701 to use slice 711. AMF 708 and SMF 713 interact to develop context for UE 701 like network addresses and quality-of-service levels. SMF 713 transfers context to UPF 715. AMF 708 transfers context to 5GNR AN 702. AMF 708 transfers context to UE 701 over 5GNR AN 702. In response to the context, UE 701 exchanges user data with the data system (not shown) over 5GNR AN 702 and UPF 715.

5GNR AN 702 could initiate a return to wireless network slice 710 based on new RF metrics and the RF information. For example, the RSRP and error rate indicated by the new RF metrics may now exceed the minimum RSRP and fall below the error rate maximum for slice 710. WIFI AN 703, satellite AN 704, ground station 705, and AMF 708 could be used to control the use of slice 710 based on RF metrics and RF information in a similar manner to 5GNR AN 702.

In a second example, UE 701 controls slice usage based on an RF metric. UE 701 transfers a request to use wireless network slice 710 to AMF 708 over 5GNR AN 702. AMF 708 retrieves UE information for UE 701 from UDM 709. The UE information includes an authorization for UE 701 to use slice 710. The UE information also includes RF information that controls the use of slice 710. AMF 708 and SMF 712 interact to develop context for UE 701 like network addresses, quality-of-service levels, and the RF information for slice 710. SMF 712 transfers context to UPF 714. AMF 708 transfers context to 5GNR AN 702. AMF 708 transfers context that includes the RF information to UE 701 over 5GNR AN 702. In response to the context, UE 701 exchanges user data with a data system like a navigation server (not shown) over 5GNR AN 702 and UPF 714.

UE 701 determines an RF metric for the exchange of user data over a wireless communication link between UE 701 and 5GNR AN 702. UE 701 selects wireless network slice 711 based on the RF metric and the RF information. For example, the RF information may specify that slice 711 should be used when the SINR for slice 710 falls below a minimum SINR and the downlink throughput falls below a minimum throughput. The RF metrics may indicate a SINR below the minimum SINR and a downlink throughput below the minimum throughput.

UE 701 transfers a request to use wireless network slice 711 to AMF 708 over 5GNR AN 702. AMF 708 retrieves UE information for UE 701 from UDM 709. The UE information includes an authorization for UE 701 to use slice 711. AMF 708 and SMF 713 interact to develop context for UE 701 like network addresses and quality-of-service levels. SMF 713 transfers context to UPF 715. AMF 708 transfers context to 5GNR AN 702. AMF 708 transfers context to UE 701 over 5GNR AN 702. In response to the context, UE 701 exchanges user data with the data system (not shown) over 5GNR AN 702 and UPF 715.

UE 701 could initiate a return to wireless network slice 710 based on new RF metrics and the RF information. For example, UE 701 may determine that the SINR indicated by the new RF metrics exceeds the minimum SINR and that the downlink throughput now exceeds the minimum downlink – and in response, UE 701 requests slice 710. UE 701 could use WIFI AN 703 and satellite AN 704 in a similar manner to 5GNR AN 702. AMF 708 may control slice usage based on RF metrics and RF information in a similar manner to UE 701.

Wireless network slice 710 may comprise a vehicle-control slice that provides navigation instructions from a remote navigation server to UE 701 which comprises a vehicle like a robotic automobile or aerial drone. For example, the navigation instruction may guide UE 701 to a building site and then direct the UE 701 to take video of the building exterior where repair work is being performed. In another example, the navigation instruction may guide a UE 701 to a delivery site and then direct UE 701 to move a package from the UE 701 to a delivery platform.

In alternative examples, the wireless communication link used to exchange the user data between UE 701 and wireless network slice 710 is a part of wireless network slice 710. 5GNR AN 702 uses another wireless communication link to exchange the user data between UE 701 and wireless network slice 711. The other wireless communication link may be a part of wireless network slice 711.

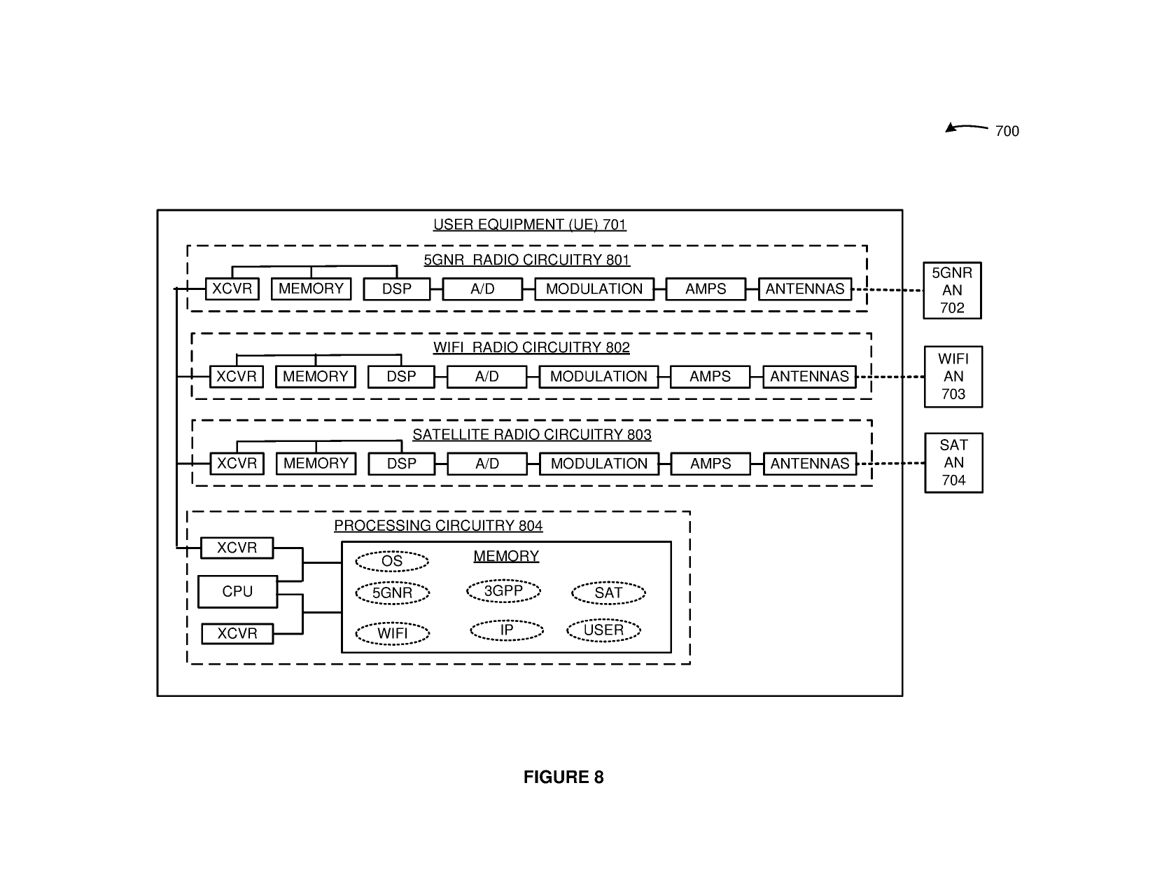

FIG. 8 illustrates exemplary UE 701 in wireless communication network 700 that controls slice usage based on the RF metric. UE 701 comprises an example of wireless communication device 101 and processing circuitry 600, although device 101 and circuitry 600 may differ. UE 701 comprises Fifth Generation New Radio (5GNR) radio circuitry 801, Wireless Fidelity (WIFI) radio circuitry 802, satellite radio circuitry 803, and processing circuitry 804. Radio circuitry 801-803 comprises antennas, amplifiers, filters, modulation, analog-to-digital interfaces, DSPs, memories, and transceivers (XCVRs) that are coupled over bus circuitry. Processing circuitry 804 comprises one or more CPUs, one or more memories, and one or more transceivers that are coupled over bus circuitry. The one or more memories in processing circuitry 804 store software like an Operating System (OS), 5GNR Application (5GNR), 3GPP Application (3GPP), WIFI Application (WIFI), Satellite Application (SAT), Internet Protocol application (IP), and user applications (USER). The antennas in radio circuitry 801-803 exchange wireless signals with ANs 702-704. Transceivers in radio circuitry 801-803 are coupled to transceivers in processing circuitry 804. In processing circuitry 804, the one or more CPUs retrieve the software from the one or more memories and execute the software to direct the operation of UE 701 as described herein. In some examples, the 5GNR application may determine RF metrics, and the 3GPP application may process the RF metrics and the RF information to request slices 710-711. In other examples, the 5GNR application may determine RF metrics, and the 3GPP application may report the RF metrics to ANs 702-704 and implement context for slices 710-711.

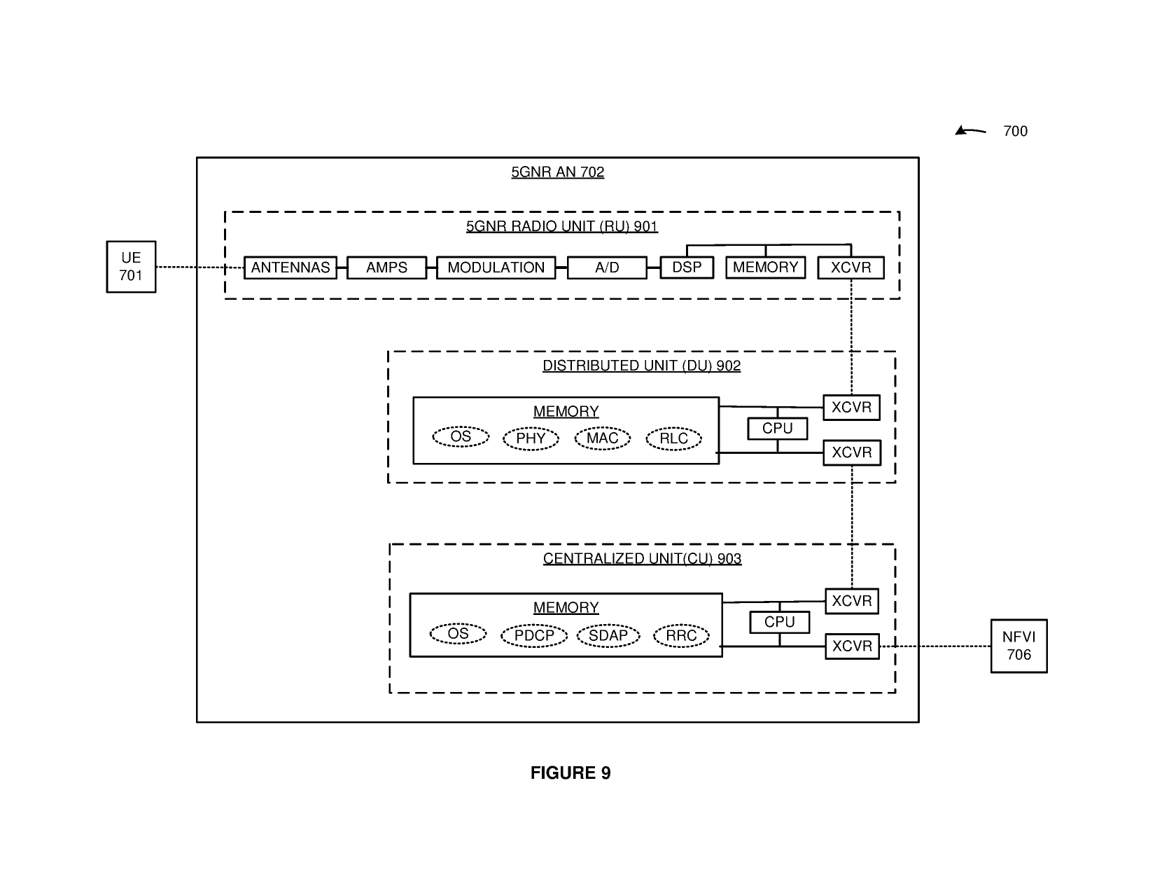

FIG. 9 illustrates exemplary Fifth Generation New Radio (5GNR) access node 702 in wireless communication network 700 that controls slice usage based on the RF metric. 5GNR AN 702 comprises an example of wireless access node 112 and processing circuitry 600, although node 112 and circuitry 600 may differ. 5GNR AN 702 comprises 5GNR Radio Unit (RU) 901, Distributed Unit (DU) 902, and Centralized Unit (CU) 903. 5GNR RU 901 comprises antennas, amplifiers, filters, modulation, analog-to-digital interfaces, DSP, memory, radio applications, and transceivers that are coupled over bus circuitry. DU 902 comprises memory, CPU, user interfaces and components, and transceivers that are coupled over bus circuitry. The memory in DU 902 stores operating system and 5GNR network applications for Physical Layer (PHY), Media Access Control (MAC), and Radio Link Control (RLC). CU 903 comprises memory, CPU, and transceivers that are coupled over bus circuitry. The memory in CU 903 stores an operating system and 5GNR network applications for Packet Data Convergence Protocol (PDCP), Service Data Adaption Protocol (SDAP), and Radio Resource Control (RRC). The antennas in 5GNR RU 901 are wirelessly coupled to UE 701 over 5GNR links. Transceivers in 5GNR RU 901 are coupled to transceivers in DU 902. Transceivers in DU 902 are coupled to transceivers in CU 903. Transceivers in CU 903 are coupled to transceivers in NFVI 706. The DSP and CPU in RU 901, DU 902, and CU 903 execute the radio applications, operating systems, and network applications to exchange data and signaling between UE 701 and NFVI 706 as described herein. In some examples, the RRC processes RF metrics from UE 701 and RF information from NFVI 706 to select and implement slices 710-711. In other examples, the RRC processes slice requests slice requests from UE 701 to implement slices 710-711 in NFVI 706.

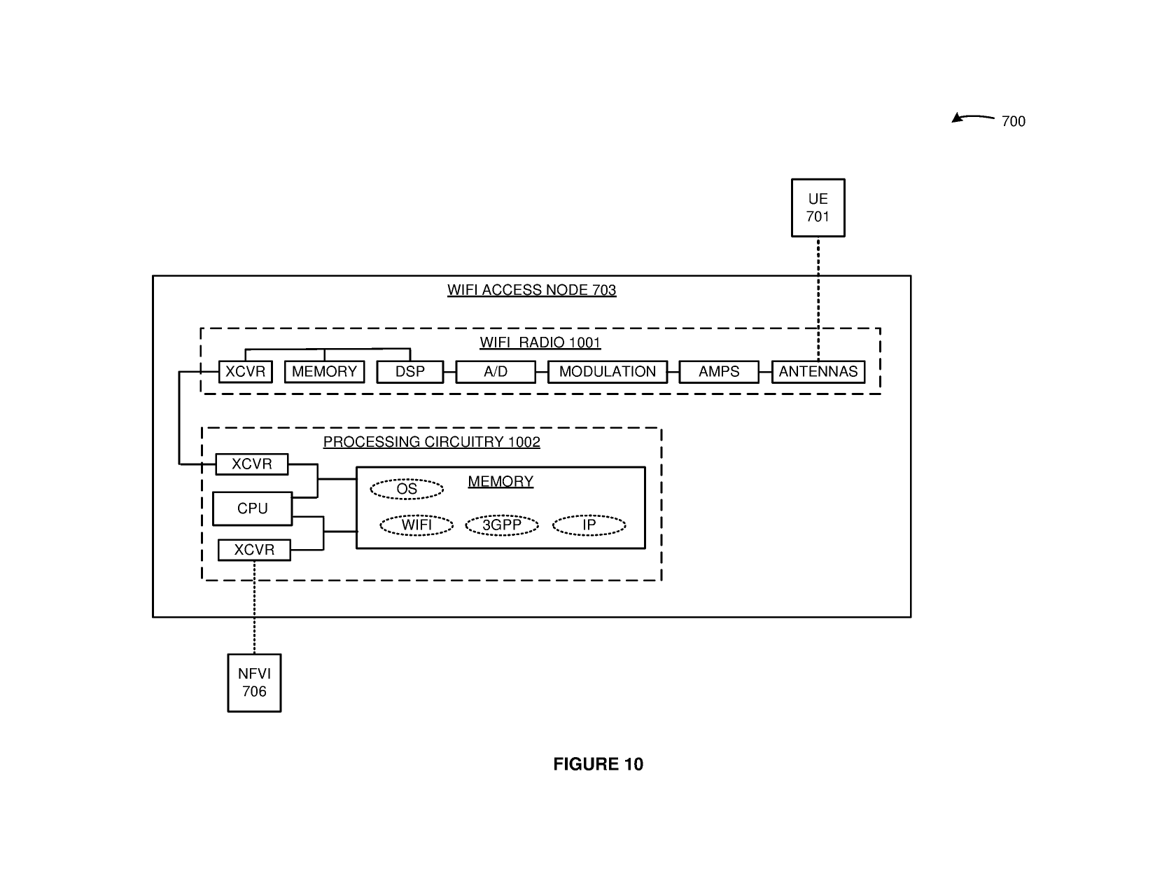

FIG. 10 illustrates an exemplary Wireless Fidelity (WIFI) access node 703 in wireless communication network 700 that controls slice usage based on the RF metric. WIFI AN 704 comprises an example of wireless access node 112 and processing circuitry 600, although node 112 and circuitry 600 may differ. WIFI AN 703 comprises WIFI radio 1001 and processing circuitry 1002. Radio 1001 comprises antennas, amplifiers, filters, modulation, analog-to-digital interfaces, DSPs, memories, and transceivers that are coupled over bus circuitry. Processing circuitry 1002 comprises one or more CPUs, one or more memories, and one or more transceivers that are coupled over bus circuitry. The one or more memories in processing circuitry 1002 store software like an Operating System (OS), WIFI application (WIFI), 3GPP application (3GPP), and IP application (IP). The antennas in WIFI radio 1001 exchange WIFI signals with UE 701. Transceivers in radio 1001 are coupled to transceivers in processing circuitry 1002. Transceivers in processing circuitry 1002 are coupled to transceivers in NFVI 706. In processing circuitry 1002, the one or more CPUs retrieve the software from the one or more memories and execute the software to exchange data and signaling between UE 701 and NFVI 706 as described herein. In some examples, the 3GPP application processes RF metrics from UE 701 and RF information from NFVI 706 to select and implement slices 710-711.

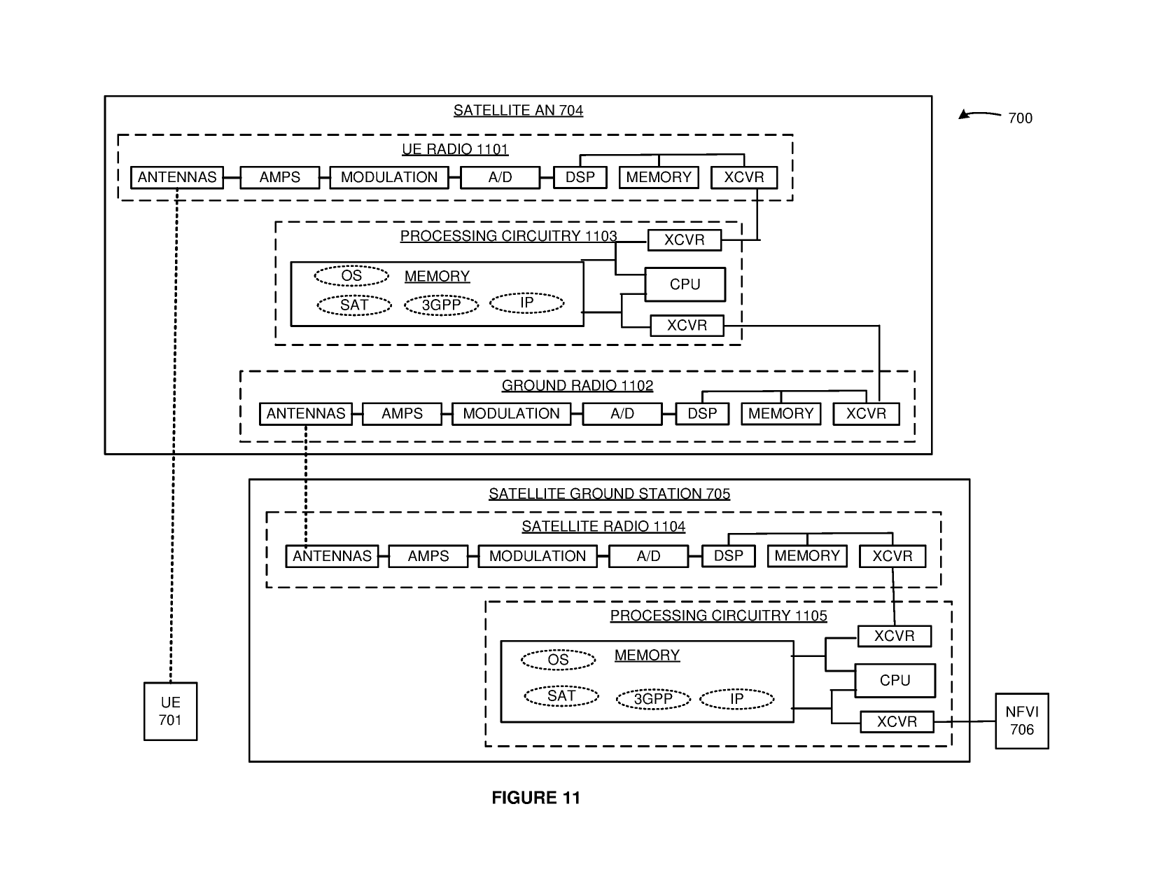

FIG. 11 illustrates exemplary satellite access node 704 and ground station 705 in wireless communication network 700 that controls slice usage based on the RF metric. Satellite AN 504 and satellite ground station 505 comprise an example of wireless access node 112 and processing circuity 600, and although node 102 and circuitry 600 may differ. Satellite AN 704 comprises UE radio 1101, ground radio 1102 and processing circuitry 1103. Satellite ground station 705 comprises satellite radio 1104 and processing circuitry 1105. Radios 1101-1102 and 1104 comprise antennas, amplifiers, filters, modulation, analog-to-digital interfaces, DSPs, memories, and transceivers that are coupled over bus circuitry. Processing circuitry 1103 and 1105 comprise one or more CPUs, one or more memories, and one or more transceivers that are coupled over bus circuitry. The one or more memories in processing circuitry 1103 and 1105 store software like an Operating System (OS), Satellite Application (SAT), 3GPP application (3GPP), and IP Application (IP). The antennas in UE radio 1101 exchange satellite signals with UE 701. Transceivers in UE radio 1101 are coupled to transceivers in processing circuitry 1103. Transceivers in processing circuitry 1103 are coupled to transceivers in ground radio 1102. The antennas in ground radio 1102 exchange satellite signals with antennas in satellite radio 1104, and the antennas in satellite radio 1104 exchange the satellite signals with ground radio 1102. Transceivers in satellite radio 1104 are coupled to transceivers in processing circuitry 1105. Transceivers in processing circuitry 1105 are coupled to transceivers in NFVI 706. In processing circuitry 1103 and 1105, the one or more CPUs retrieve the software from the one or more memories and execute the software to exchange data and signaling between UE 701 and NFVI 706 as described herein. In some examples, the 3GPP application in AN 704 or station 705 process RF metrics from UE 701 and RF information from NFVI 706 to select and implement slices 710-711.

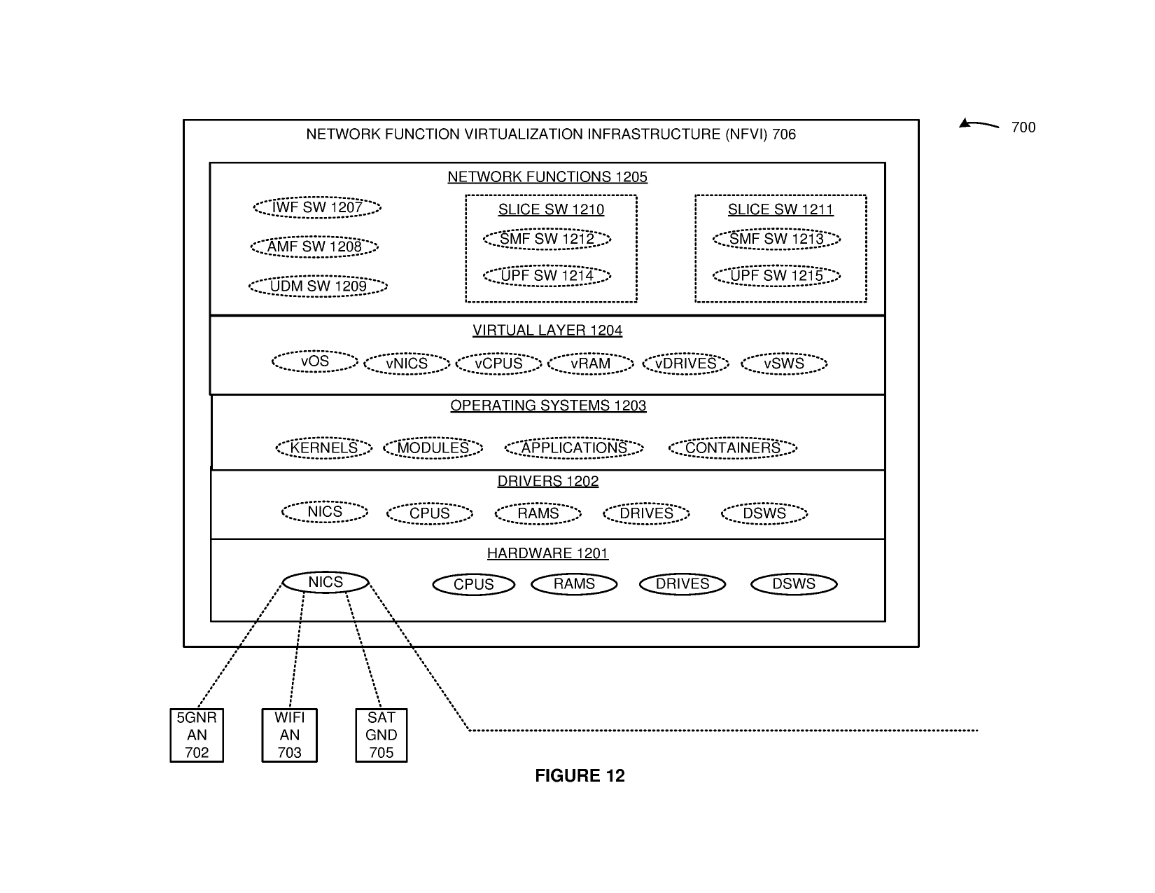

FIG. 12 illustrates exemplary Network Function Virtualization Infrastructure (NFVI) 706 in wireless communication network 700 that controls slice usage based on the RF metric. NFVI 706 comprises an example of network control system 111, wireless network slices 114-115, and processing circuitry 600, although system 111, slices 114-115, and circuitry 600 may differ. NFVI 706 comprises hardware 1201, hardware drivers 1202, operating systems 1203, virtual layer 1204, and network functions 1205. Hardware 1201 comprises Network Interface Cards (NICS), CPUS, RAM, Flash/Disk Drives (DRIVES), and Data Switches (DSWS). Hardware drivers 1202 comprise software that is resident in the NICS, CPUS, RAM, DRIVES, and DSWS. Operating systems 1203 comprise kernels, modules, applications, and containers. Virtual layer 1204 comprises virtual Operating Systems (vOS), vNICS, vCPUS, vRAM, vDRIVES, and vSWS. Network Functions 1205 comprises IWF SW 1207, AMF SW 1208, UDM SW 1209, and network slice SW 1210-1211. Network slice SW 1210 comprises SMF SW 1212 and UPF SW 1214. Network slice SW 1211 comprises SMF SW 1213 and UPF SW 1215. The NICS in hardware 1201 are coupled to ANs 702-703, satellite ground station 705, and external systems (not shown). Hardware 1201 executes hardware drivers 1202, operating systems 1203, virtual layer 1204, and network functions 1205 to form and operate IWF 707, AMF 708, UDM 709, SMFs 712-713, and UPFs 714-715 as described herein. NFVI 706 comprises one or more microprocessors and one or more non-transitory machine-readable storage media that store processing instructions that direct NFVI 706 to exchange data and signaling between ANs 502-503, satellite ground station 705, and external systems as described herein. In some examples, AMF SW 1208 retrieves RF information from UDM SW 1209 and transfers the RF information to UE 701 and/or ANs 702-704. AMF SW 1208 implements slices 710-711 based on requests from UE 701 and/or ANs 702-704. AMF SW 1208 may control slice usage based on RF metrics and RF information in a similar manner to UE 701 and ANs 702-704.

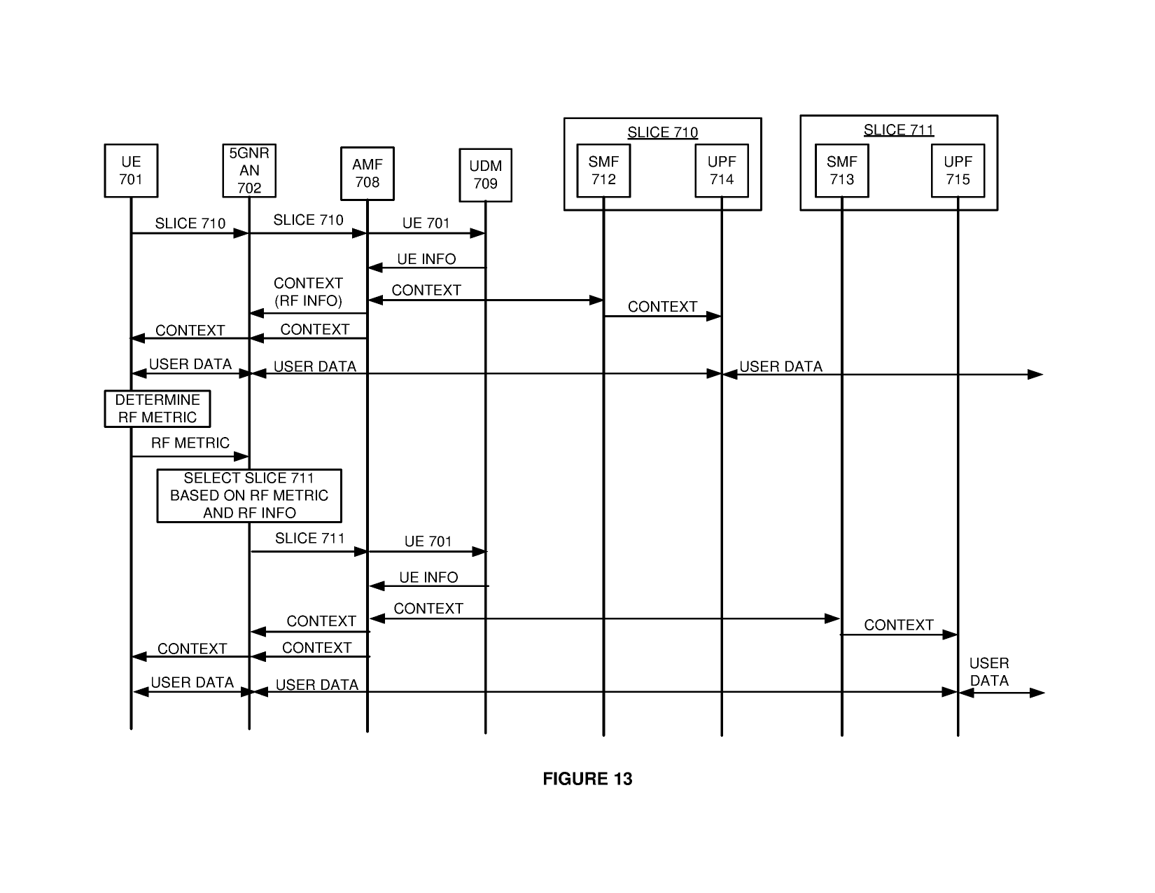

FIG. 13 illustrates an exemplary operation of wireless communication network 700 that controls slice usage based on the RF metric. The operation may vary in other examples. In this example, 5GNR AN 702 controls slice usage based on an RF metric. UE 701 transfers a request to use wireless network slice 710 to AMF 708 over 5GNR AN 702. AMF 708 retrieves UE information for UE 701 from UDM 709. The UE information includes an authorization for UE 701 to use slice 710 and RF information that controls the use of slice 710. AMF 708 and SMF 712 interact to develop context for UE 701 like network addresses, quality-of-service levels, and the RF information for slice 710. SMF 712 transfers context to UPF 714. AMF 708 transfers context that includes the RF information to 5GNR AN 702. AMF 708 transfers context to UE 701 over 5GNR AN 702. In response to the context, UE 701 exchanges user data with a data system (not shown) over 5GNR AN 702 and UPF 714. UE 701 determines an RF metric for the exchange of user data over a wireless communication link between UE 701 and 5GNR AN 702. UE 701 transfers the RF metric to 5GNR AN 701. 5GNR 701 selects wireless network slice 711 based on the RF metric and the RF information. For example, the RF information may specify a minimum RSRP to use slice 710, and the RF metric may indicate an RSRP below the minimum. 5GNR AN 702 transfers a request for UE 701 to use wireless network slice 711 to AMF 708. AMF 708 retrieves UE information for UE 701 from UDM 709. The UE information includes an authorization for UE 701 to use slice 711. AMF 708 and SMF 713 interact to develop context for UE 701 like network addresses and quality-of-service levels. SMF 713 transfers context to UPF 715. AMF 708 transfers context to 5GNR AN 702. AMF 708 transfers context to UE 701 over 5GNR AN 702. In response to the context, UE 701 stops using slice 710 and now exchanges user data with the data system (not shown) over 5GNR AN 702 and UPF 715.

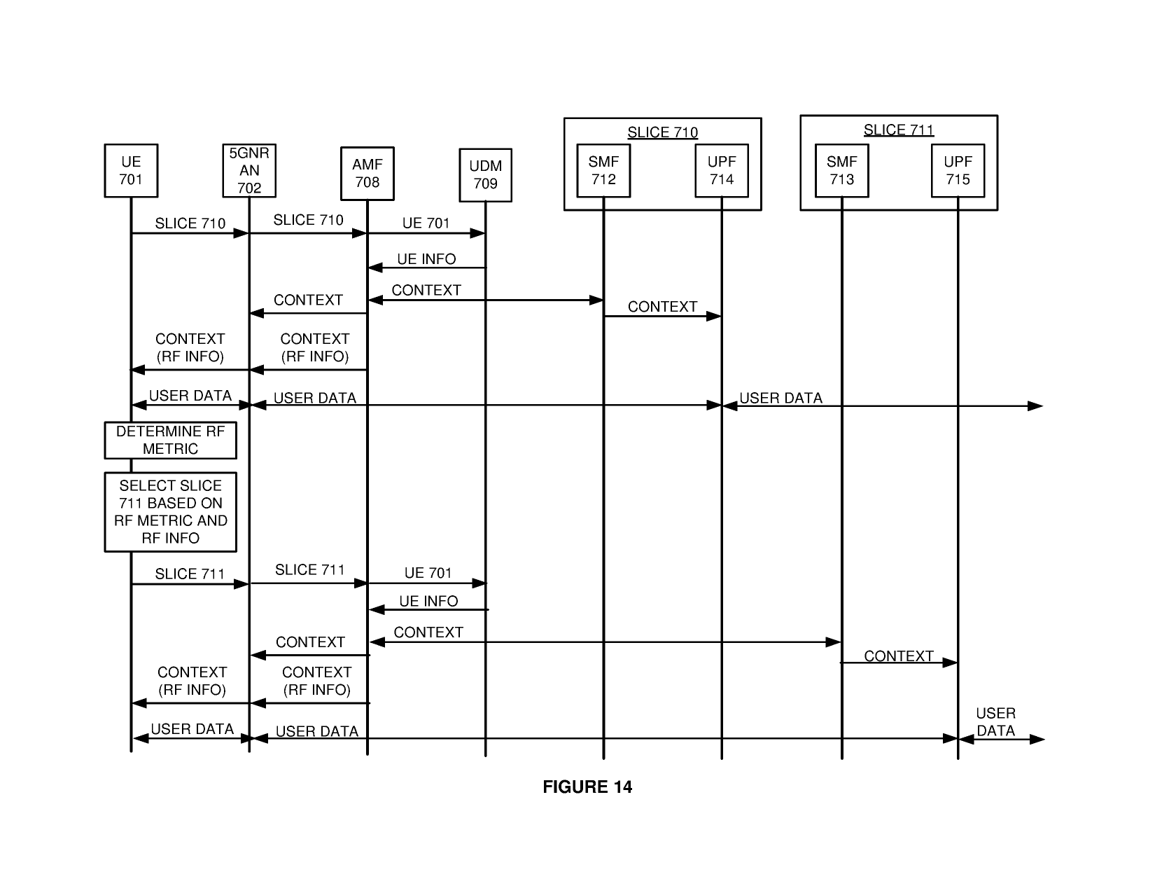

FIG. 14 illustrates an exemplary operation of wireless communication network 700 that controls slice usage based on the RF metric. The operation may vary in other examples. In this example, UE 701 controls slice usage based on an RF metric. UE 701 transfers a request to use wireless network slice 710 to AMF 708 over 5GNR AN 702. AMF 708 retrieves UE information for UE 701 from UDM 709. The UE information includes an authorization for UE 701 to use slices 710-711 and RF information that controls the use of slice 710. AMF 708 and SMF 712 interact to develop context for UE 701 like network addresses, quality-of-service levels, and the RF information for slice 710. SMF 712 transfers context to UPF 714. AMF 708 transfers context to 5GNR AN 702. AMF 708 transfers context that includes the RF information to UE 701 over 5GNR AN 702. In response to the context, UE 701 exchanges user data with a data system (not shown) over 5GNR AN 702 and UPF 714. UE 701 determines an RF metric for the exchange of user data over a wireless communication link between UE 701 and 5GNR AN 702. UE 701 selects wireless network slice 711 based on the RF metric and the RF information. For example, the RF information may specify a minimum SINR to use slice 710, and the RF metric may indicate a SINR below the minimum. UE 701 transfers a request to use wireless network slice 711 to AMF 708 over 5GNR AN 702. AMF 708 retrieves UE information for UE 701 from UDM 709. The UE information includes an authorization for UE 701 to use slice 711. AMF 708 and SMF 713 interact to develop context for UE 701 like network addresses and quality-of-service levels. SMF 713 transfers context to UPF 715. AMF 708 transfers context to 5GNR AN 702. AMF 708 transfers context to UE 701 over 5GNR AN 702. In response to the context, UE 701 stops using slice 710 and now exchanges user data with the data system (not shown) over 5GNR AN 702 and UPF 715.

Advantageously, wireless communication network 700 efficiently controls slice usage based on RF metrics for wireless communication links that are used by wireless UE 701. Moreover, wireless communication network 700 effectively coordinates the capabilities of wireless network slices 710-711 with the qualities of the wireless communication links that connect UE 701 to slices 710-711.

The wireless communication system circuitry described above comprises computer hardware and software that form special-purpose data communication circuitry to control slice usage based on RF metrics and information. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry system to control slice usage based on the RF metrics and information.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
exchanging user data with a wireless communication device that is using a wireless network slice that has RF information that controls slice usage;
receiving a Radio Frequency (RF) metric for a wireless communication link from the wireless communication device; and
processing the RF metric and the RF information, and in response, selecting another network slice, stopping the exchange of the user data with the wireless communication device that was using the wireless network slice, and exchanging other user data with the wireless communication device that is using the other network slice.

2. The method of claim 1, wherein:
the wireless network slice comprises the wireless communication link;
exchanging the user data with the wireless communication device comprises exchanging the user data with the wireless communication device over the wireless communication link in the wireless network slice; and
exchanging the other user data with the wireless communication device comprises exchanging the other user data with the wireless communication device over another communication link in the other network slice.

3. The method of claim 1, wherein:
exchanging the user data with the wireless communication device comprises exchanging the user data with the wireless communication device over the wireless communication link; and
exchanging the other user data with the wireless communication device comprises exchanging the other user data with the wireless communication device over the wireless communication link.

4. The method of claim 1, further comprising modifying the RF information, and in response, modifying a physical boundary of the wireless network slice.

5. The method of claim 1, further comprising generating a coverage map for the wireless network slice based on a physical location of the wireless communication device when the other network slice is selected.

6. The method of claim 1, wherein exchanging the user data with the wireless communication device comprises using Multiple Input Multiple Output (MIMO) beamforming.

7. The method of claim 1, wherein:
the wireless communication device comprises a vehicle; and
the wireless network slice comprises a vehicle-control slice.

8. A method comprising:
receiving a request from a wireless communication device to use a wireless network slice;
in response to the request, transferring Radio Frequency (RF) information that controls slice usage to the wireless communication device;
exchanging user data with the wireless communication device that is using the wireless network slice;
receiving another request from the wireless communication device to use another network slice wherein the wireless communication device determines an RF metric for a wireless communication link and selects the other network slice based on the RF metric and the RF information; and
in response to the other request, exchanging other user data with the wireless communication device that is using the other network slice.

9. The method of claim 8, wherein:
the wireless network slice comprises the wireless communication link;
exchanging the user data with the wireless communication device comprises exchanging the user data with the wireless communication device over the wireless communication link in the wireless network slice; and
exchanging the other user data with the wireless communication device comprises exchanging the other user data with the wireless communication device over another wireless communication link in the other network slice.

10. The method of claim 8, wherein:
exchanging the user data with the wireless communication device comprises exchanging the user data with the wireless communication device over the wireless communication link; and
exchanging the other user data with the wireless communication device comprises exchanging the other user data with the wireless communication device over the wireless communication link.

11. The method of claim 8, further comprising modifying the RF information, and in response, modifying a physical boundary of the wireless network slice.

12. The method of claim 8, further comprising generating a coverage map for the wireless network slice based on a physical location of the wireless communication device when the other network slice is selected.

13. The method of claim 8, wherein exchanging the user data with the wireless communication device comprises using Multiple Input Multiple Output (MIMO) beamforming.

14. The method of claim 8, wherein:
the wireless communication device comprises a vehicle; and
the wireless network slice comprises a vehicle-control slice.

15. A wireless communication network comprising:
a wireless access node to exchange user data with a wireless communication device that is using a wireless network slice;
a control system to transfer Radio Frequency (RF) information that controls usage of the wireless network slice to the wireless access node;
the wireless access node to receive an RF metric for a wireless communication link from the wireless communication device;
the wireless access node to process the RF metric and the RF information, and in response, select another network slice; and
in response to the selection, the wireless access node to stop the exchange of the user data with the wireless communication device that was using the wireless network slice and to exchange other user data with the wireless communication device that is using the other network slice.

16. The wireless communication network of claim 15, wherein:
the wireless network slice comprises the wireless communication link and the wireless access node;
the wireless access node is to exchange the user data with the wireless communication device over the wireless communication link in the wireless network slice; and further comprising
another wireless access node to exchange the other user data with the wireless communication device over another wireless communication link in the other network slice.

17. The method of claim 1, wherein:
the wireless access node is to exchange the user data with the wireless communication device over the wireless communication link; and
the wireless access node is to exchange the other user data with the wireless communication device over the wireless communication link.

18. The wireless communication network of claim 15, further comprising the control system to modify the RF information, and in response, modify a physical boundary of the wireless network slice.

19. The wireless communication network of claim 15, wherein the control system is to generate a coverage map for the wireless network slice based on a physical location of the wireless communication device when the other network slice is selected.

20. The wireless communication network of claim 15, wherein the wireless access node is to use Multiple Input Multiple Output (MIMO) beamforming to exchange the user data with the wireless communication device.
